(19) United States
(12) Patent Application Publication
(10) Pub. No.: US 2005/0054432 A1
(43) Pub. Date: Mar. 10, 2005

(54) Gaming method and machine with bonus round

(76) Inventor: William George Amos, Moncton (CA)

Correspondence Address: GOWLING LAFLEUR HENDERSON, LLP;Suite 2600, 160 Elgin Street, Ottawa, ON, K1P 1C3, CA

(21) Appl. No.: 10/926,943

(22) Filed: Aug. 27, 2004

Related U.S. Application Data
(60) Provisional application No. 60/497,914, filed on Aug. 27, 2003.

(51) Int. Cl. A63F 13/00

(52) U.S. Cl. 463/25

(57) ABSTRACT

The present invention provides a way of awarding a bonus round while complying with regulations that restrict gaming machine features for certain venues. For a five-reel, five payline game having seven game elements, three of which are fruit elements, a bonus round is triggered whenever all elements of a three row by 5 reel display are fruit elements. The winning screen is then used as a pick-a-prize screen. Animation is used to transform the chosen fruit into the bonus point award.

### FIELD OF THE INVENTION

The present invention relates to gaming methods and machines and is particularly concerned with bonus rounds.

### BACKGROUND OF THE INVENTION

Video gaming machines are commonly used in traditional gambling establishments such as casinos and gambling centers and in other markets such as bars, restaurants, racinos, bingo halls, riverboats, and cruise ships. While the regulations covering these different establishments are different, they also vary from one jurisdiction to another and the habits of players may also vary. Hence, a game that can attract and maintain the interest of a player provides higher value to the proprietor. Consequently, there is a need to continually improve game features, while maintaining a fairly high level of familiarity so that established players can also enjoy the new game features.

Because the number of games allowed within an establishment are typically regulated and because the gaming machines have a relatively short payback cycle, the gaming machine business is highly competitive. Hence there is further pressure on the industry to make improvements in game features that enhance their play value.

Gaming machines provide games that fall into general categories that emulate traditional games of chance such as keno, bingo, scratch tickets, fixed-odds betting, other types of wager games, slot-machine emulation and card game emulation. These typically reward a player having a predetermined outcome with a bonus round of play or other incentives. However there is a need for further innovation in card game based screen based gaming that may provide an advantage with regard to playability, player loyalty or profitability.

### SUMMARY OF THE INVENTION

An object of the present invention is to provide improved gaming method and machine with bonus round.

In accordance with an aspect of the present invention there is provided a gaming method with bonus round comprising the steps of, during a regular play session, providing a bonus trigger; on hitting the bonus trigger during a regular play session rewarding a bonus round for a given game screen; and providing the bonus round using the given game screen.

In accordance with another aspect of the present invention there is provided a gaming machine with bonus round comprising means for providing a bonus trigger during a regular play session; means for rewarding bonus play for a given game screen on hitting the bonus trigger during a regular play session; and means for providing bonus play using the given game screen.

### BRIEF DESCRIPTION OF THE DRAWINGS

The present invention will be further understood from the following detailed description with reference to the drawings in which:

FIG. 1 illustrates gaming machine with bonus round in accordance with an embodiment of the present invention;

FIG. 2 illustrates in a block diagram, a computer system of the gaming machine of FIG. 1;

FIG. 3 illustrates game symbols for a gaming machine in accordance with a first embodiment of the present invention;

FIG. 4 illustrates a sample game screen for a gaming machine in accordance with the first embodiment of the present invention;

FIG. 5 illustrates a sample bonus screen for a gaming machine game in accordance with the first embodiment of the present invention; and

FIG. 6 illustrates the sample bonus screen of FIG. 5 after a player selection have been made;

FIG. 7 illustrates the sample bonus screen of FIG. 5 after the player picks a fruit;

FIG. 8 illustrates the sample bonus screen of FIG. 5 after a player selection has resulted in a “collect” being displayed.

### DETAILED DESCRIPTION OF THE PREFERRED EMBODIMENT

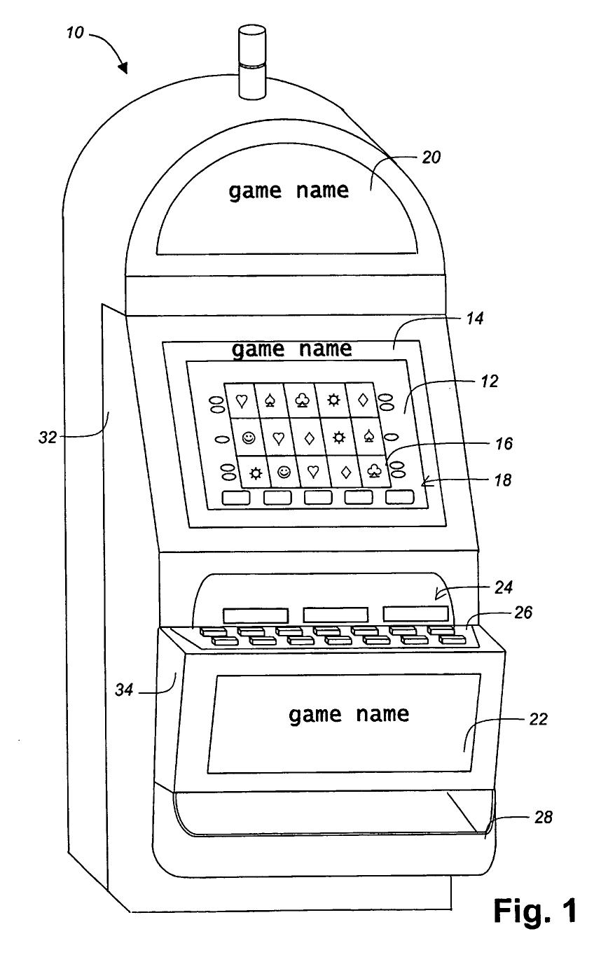

Referring to FIG. 1, there is illustrated in a isometric view a gaming machine programmable to implement the present invention. The gaming machine 10 includes a touch screen 12 that incorporates a game banner 14, a game screen 16 and soft keys 18. The gaming machine 10 also typically includes game display glasses 20 and 22, payment input and output devices 24, a keyboard 26 and a cash tray 28 all housed in a cabinet 30. The cabinet 30 includes a hinged front panel 32 and a hinged access door 34.

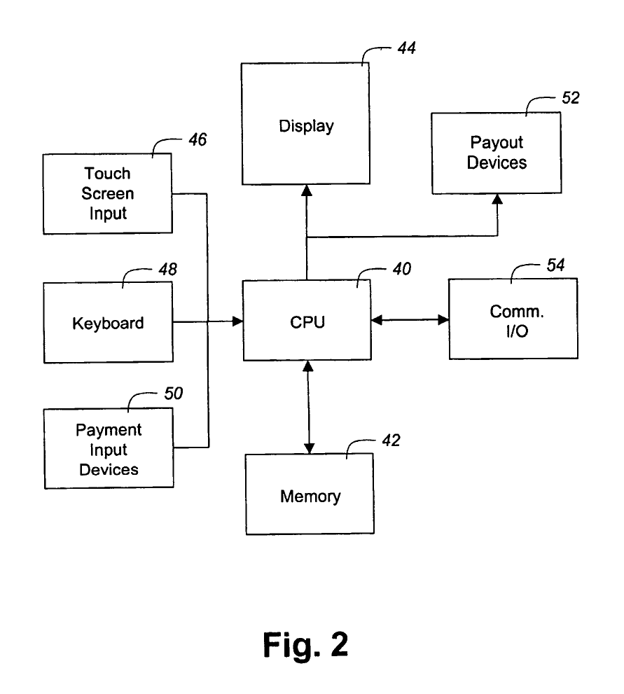

Referring to FIG. 2, there is illustrated in a block diagram a computer system of the gaming machine of FIG. 1. The computer system includes a central processing unit (CPU), a memory 42 and a display 44. The computer system also includes a touch screen input 46, a keyboard 48, payment input devices 50, payment output devices 52 and a communications interface 54.

In operation, the gaming machine 10 under the control of a gaming program operating the CPU 40 provides, in the game screen 16 of the display 44, a representation of an m reel by n row slot machine emulation. A player on pressing a soft key 18 marked “Play” causes the gaming machine 10 to display a spin of the reels until a display of m×n game symbols are shown in the display area. Typically a number of pay lines are provided for the player to pre-select prior to pressing the play button. Then, depending upon the particular game programmed into the CPU 40, when a predetermined outcome occurs along one of the selected pay lines, the player is rewarded with an increment to a credits counter.

As such gaming machines are a familiar sight in various establishments, the gaming industry has continuously sought ways to improve the game features to enhance qualities such as player loyalty, playability and hence profitability of the gaming machines. One such improvement over the slot machine, is the ability of the display-based gaming machine 10 to provide an additional round of play, in the form of a bonus round. Typically, the bonus round is an automatic spin that provides the player with an opportunity to win additional credits, beyond those won during regular play. However, some gaming regulations may restrict the type of bonus that can be used.

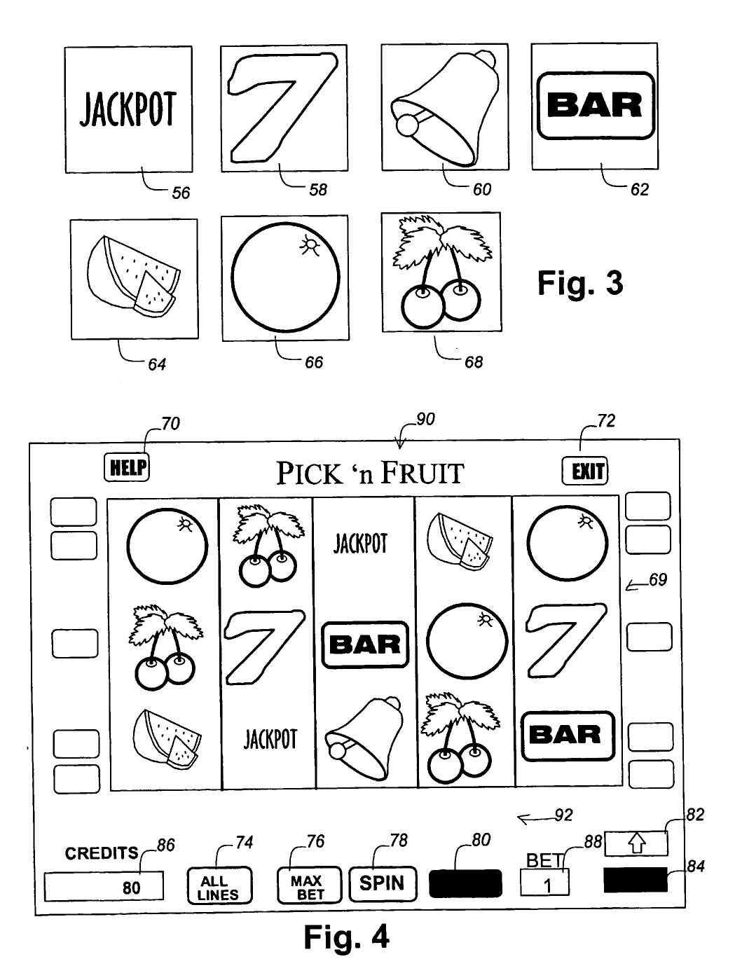

Referring to FIGS. 3 and 4 there are pictorially illustrated game symbols and the game screen for a gaming machine game in accordance with an embodiment of the present invention. In accordance with the second embodiment during the bonus round a player may win an additional spin or a predetermined number of additional spins, for example five additional spins, when a bonus trigger outcome occurs during the bonus round. The additional spins are added to the current bonus spin total.

The embodiment of FIGS. 3 and 4 is a five reel, five payline game that pays for three or more identical elements in a row on either the left side or the right side of each payline.

This game allows full independent betting. The player may decrease the wager on paylines by touching the left tags or increase the payline wager by touching the right tags. And the player may set the wager for any given payline from 0 to the maximum wager of 10 credits. This also means that capping of wins is allowed.

There are a total of seven regular elements that occupy all the five reels as shown in FIGS. 3 and 4. These are a jackpot 56, a seven 58, a bell 60, a bar 62, a melon 64, an orange 66, and cherries 68.

As shown in FIG. 4, the game screen 12 includes a themed background (not shown), a 5-reel by 3-row element area 69, and soft keys 18. The soft keys include a help button 70, an exit button 72, an all lines button 74, a max bet button 76, a spin button 78, a clear button 80, and bet up/down buttons 82 and 84. The game screen 12 also includes a credit window 86, a bet window 88, a pick 'n fruit logo 90 and a lower prompt area 92. Note that the CLEAR and BET DOWN buttons are gray and not functional when the minimum bet is in place and the bet can never be cleared to zero.

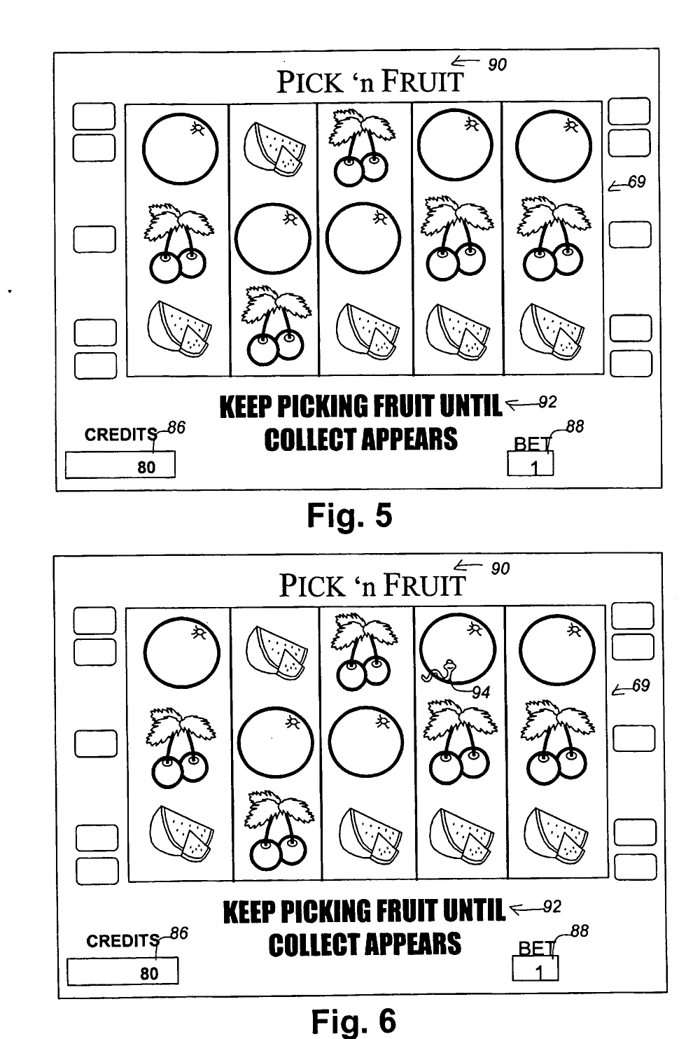

An all fruit game screen acts as the bonus trigger as shown by example in FIG. 5. The single bonus feature of the embodiment occurs when only fruit symbols (melon 64, orange 66 and cherries 68) appear in the 3×5 element area 69 on the same spin. A message “KEEP PICKING FRUIT UNTIL COLLECT APPEARS” is placed in the lower prompt area 92. Rather than changing the game screen from the bonus trigger screen to a second bonus screen as is typically done, the embodiment of FIGS. 3-8 uses the bonus triggering screen, a sample of which is shown in FIG. 5, as a “pick a prize” bonus screen.

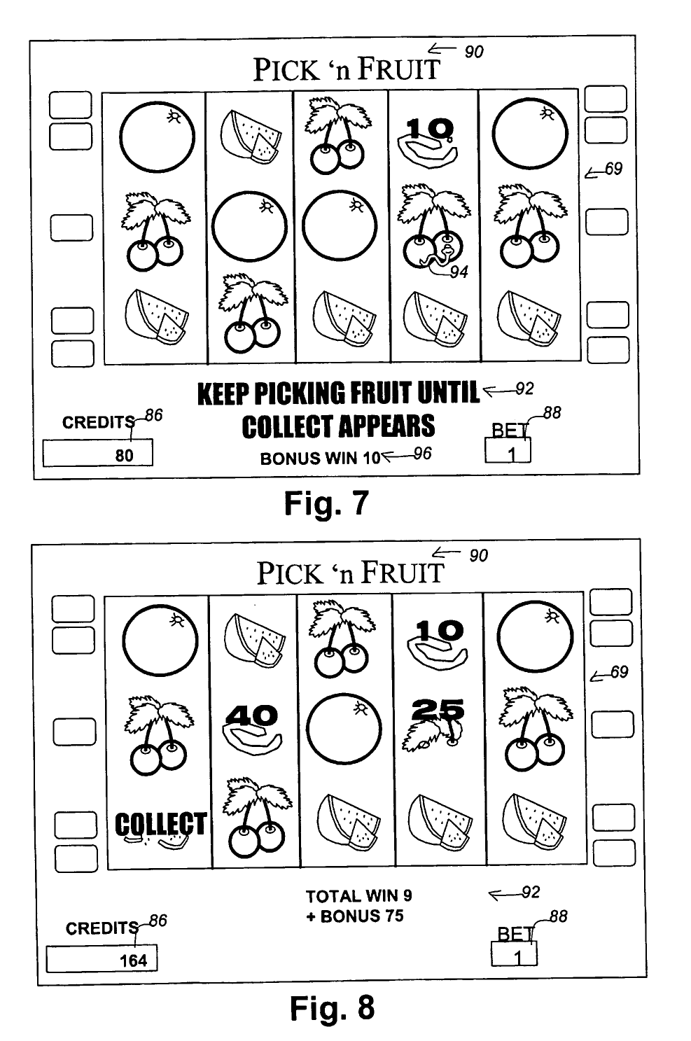

Referring to FIG. 6 there is illustrated the sample bonus screen of FIG. 5 after a player selection has been made. After the player picks a fruit, a worm 94 appears and eats the fruit to reveal the bonus points associated with that fruit element, as shown in FIG. 7. Also shown in FIG. 7, the player has selected the cherries fruit element on the same reel, hence the worm 94 appears again. A bonus points total 96 displays the bonus points for the fruit selected.

Referring to FIG. 8, there is illustrated the sample bonus screen of FIG. 5 after a player selection has resulted in a “collect” being displayed. The message “KEEP PICKING FRUIT UNTIL COLLECT APPEARS” is replaced in the lower prompt area 92 with “TOTAL WIN X+BONUS YY”. This lets the player know that the bonus round has ended and the outcome of the bonus round.

1. A gaming method with bonus round for a display screen gaming machine comprising the steps of:
during a regular play session, providing a bonus trigger;
on hitting the bonus trigger during a regular play session rewarding a bonus round for a given game screen; and
providing the bonus round using the given game screen.

2. A method as claimed in claim 1 wherein the bonus play includes a pick a prize.

3. A method as claimed in claim 2 wherein the bonus play includes win credit multiplier.

4. A method as claimed in claim 3 wherein the win credit multiplier is predetermined.

5. A method as claimed in claim 3 wherein the win credit multiplier is a variable.

6. A method as claimed in claim 5 wherein the variable is a randomly selected from 2, 3 and 4.

7. A method as claimed in claim 1 further comprising incrementing a progressive counter in dependence upon one of regular play and bonus play

8. A method as claimed in claim 1 further comprising allowing a player to select a risk level before beginning the bonus play.

9. A gaming machine with bonus round comprising:
means for providing a bonus trigger during a regular play session;
means for rewarding bonus play for a given game screen on hitting the bonus trigger during a regular play session; and
means for providing bonus play using the given game screen.

10. A method as claimed in claim 9 wherein the bonus play includes a pick a prize.

11. A gaming machine as claimed in claim 10 wherein the bonus play includes win credit multiplier.

12. A gaming machine as claimed in claim 11 wherein the win credit multiplier is predetermined.

13. A gaming machine as claimed in claim 12 wherein the win credit multiplier is a variable.

14. A gaming machine as claimed in claim 13 wherein the variable is a randomly selected from 2, 3 and 4.
